(19) United States
(12) Patent Application Publication
(10) Pub. No.: US 2026/0016718 A1
(43) Pub. Date: Jan. 15, 2026

(54) DISPLAY PANEL AND DISPLAY DEVICE

(71) Applicants: HEFEI BOE OPTOELECTRONICS TECHNOLOGY CO., LTD., Hefei (CN); BOE TECHNOLOGY GROUP CO., LTD., Beijing (CN); BEIJING BOE TECHNOLOGY DEVELOPMENT CO., LTD., Beijing (CN)

(72) Inventors: Wencheng Hu, Beijing (CN); Jinming Zhu, Beijing (CN); Hui Li, Beijing (CN); Zhengwei Zhu, Beijing (CN); Cheng Li, Beijing (CN); Kun Yu, Beijing (CN); Bing Wang, Beijing (CN); Zhiyuan Yang, Beijing (CN)

(21) Appl. No.: 18/995,700

(22) PCT Filed: May 14, 2024
(86) PCT No.: PCT/CN2024/093162

§ 371 Date: Jan. 16, 2025

(30) Foreign Application Priority Data
Jun. 25, 2023 (CN) 202310760124.9

(51) Int. Cl. G02F 1/1335; G02F 1/133; G02F 1/1339

(52) U.S. Cl. CPC G02F 1/133514; G02F 1/13306; G02F 1/133512; G02F 1/13396

(57) ABSTRACT

Provided are a display panel and a display device. The display panel includes a display region and a peripheral region including a first sub peripheral region. The display panel includes: a first substrate including: a first base; and a black matrix and color resistance portions on the first base, where color resistance portions are arranged in the display region; and spacers on the first base, where the spacers include a first spacer located in the first sub peripheral region and a second spacer located in the display region; a second substrate opposite to the first substrate, including: a second base; pixel driving circuits on the second base; and a driving chip on the second base, where the driving chip is located in the first sub peripheral region; and a sealing adhesive between the first substrate and the second substrate, where the sealing adhesive surrounds the display region.

### CROSS-REFERENCE TO RELATED APPLICATION(S)

This application is a Section 371 National Stage Application of International Application No. PCT/CN2024/093162, filed on May 14, 2024, entitled “DISPLAY PANEL AND DISPLAY DEVICE”, which claims priority to Chinese Application No. 202310760124.9, filed on Jun. 25, 2023, the contents of which are incorporated herein by reference in their entireties.

### TECHNICAL FIELD

The present disclosure relates to a field of display technology, in particular to a display panel and a display device including the display panel.

### BACKGROUND

In a process of manufacturing a liquid crystal display panel, it is needed to bond an IC chip (Integrated Circuit Chip) on the display panel, and COG (Chip On Glass) method is generally used to achieve an electrical connection between the IC and leads on a glass substrate. IC is mainly combined with the glass substrate through an anisotropic conductive film (ACF). Due to differences in thermal expansion coefficients of the three materials, the glass substrate is prone to deformation and warping after the manufacturing is completed, which has a stress effect on the glass substrate, thereby causing the product to occur light leakage (COG Mura phenomenon).

The above information disclosed in this section is only used for the understanding of the background of the technical concept of the present disclosure. Therefore, the above information may contain information that does not constitute the prior art.

### SUMMARY

In a first aspect, there is provided a display panel including a display region and a peripheral region, where the peripheral region at least partially surrounds the display region, the peripheral region includes a first sub peripheral region. The display panel includes: a first substrate including a first base; and a black matrix and a plurality of color resistance portions on the first base, where the plurality of color resistance portions are arranged in an array in a first direction and a second direction in the display region; and a plurality of spacers on the first base, where the plurality of spacers include a first spacer located in the first sub peripheral region and a second spacer located in the display region; a second substrate opposite to the first substrate, where the second substrate includes: a second base; a plurality of pixel driving circuits on the second base, where the plurality of pixel driving circuits are arranged in an array in the first direction and the second direction in the display region; and a driving chip on the second base, where the driving chip is located in the first sub peripheral region; and a sealing adhesive between the first substrate and the second substrate, where the sealing adhesive surrounds the display region, where the first spacer is located on a side of the sealing adhesive away from the display region, the first spacer is located between the sealing adhesive and the driving chip in the first direction, and the first direction is a direction pointing from a center of the display region to the driving chip; and where the display panel further includes a cushion layer structure on the first base, and the first spacer is located on a side of the cushion layer structure facing the second substrate.

According to some exemplary embodiments, an orthographic projection of the first spacer on the first base falls within an orthographic projection of the cushion layer structure on the first base.

According to some exemplary embodiments, an orthographic projection of the first spacer in the first direction at least partially overlaps with an orthographic projection of the driving chip in the first direction.

According to some exemplary embodiments, the first spacer and the sealing adhesive are spaced apart in the first direction, and a minimum interval distance between the first spacer and the sealing adhesive in the first direction is a first interval distance; the first spacer and the driving chip are spaced apart in the first direction, and a minimum interval distance between the first spacer and the driving chip in the first direction is a second interval distance; and the first interval distance is less than the second interval distance.

According to some exemplary embodiments, the display panel includes a plurality of first spacers, and the plurality of first spacers are located between the sealing adhesive and the driving chip in the first direction; and the plurality of first spacers are spaced apart in the second direction, and the second direction is perpendicular to the first direction.

According to some exemplary embodiments, a size of a region in which a plurality of first spacers are distributed in the second direction is greater than a size of the driving chip in the second direction.

According to some exemplary embodiments, a region in which a plurality of first spacers are distributed includes a first sub-region, a second sub-region and a third sub-region. The second sub-region and the third sub-region are located on two sides of the first sub-region in the second direction respectively, and the first sub-region is opposite to the driving chip in the first direction; and a ratio of a size of the second sub-region in the second direction to a size of the first sub-region in the second direction is between 0.1 and 0.4; and/or, a ratio of a size of the third sub-region in the second direction to the size of the first sub-region in the second direction is between 0.1 and 0.4.

According to some exemplary embodiments, a region in which a plurality of first spacers are distributed includes a first sub-region, a second sub-region and a third sub-region. The second sub-region and the third sub-region are located on two sides of the first sub-region in the second direction respectively. The first sub-region is opposite to the driving chip in the first direction. The plurality of first spacers have a first distribution density in the first sub-region. The plurality of first spacers have a second distribution density in the second sub-region. The plurality of first spacers have a third distribution density in the third sub-region. The first distribution density is greater than the second distribution density. The first distribution density is greater than the third distribution density.

According to some exemplary embodiments, the region in which the plurality of first spacers are distributed further includes a fourth sub-region and a fifth sub-region. The fourth sub-region is located on a side of the second sub-region away from the first sub-region in the second direction. The fifth sub-region is located on a side of the third sub-region away from the first sub-region in the second direction. The plurality of first spacers have a fourth distribution density in the fourth sub-region. The plurality of first spacers have a fifth distribution density in the fifth sub-region. The second distribution density is greater than the fourth distribution density. The third distribution density is greater than the fifth distribution density.

According to some exemplary embodiments, the second distribution density is equal to the third distribution density; and/or, the fourth distribution density is equal to the fifth distribution density.

According to some exemplary embodiments, a ratio of a size of the second sub-region in the second direction to a size of the first sub-region in the second direction is between 0.1 and 0.4; and/or, a ratio of a size of the third sub-region in the second direction to the size of the first sub-region in the second direction is between 0.1 and 0.4.

According to some exemplary embodiments, a plurality of first spacers are arranged in one row in the first direction, and the plurality of first spacers located in the row are arranged at equal intervals in the second direction.

According to some exemplary embodiments, a plurality of first spacers are arranged in a plurality of rows in the first direction, and the plurality of first spacers located in the same row are arranged at equal intervals in the second direction.

According to some exemplary embodiments, the plurality of first spacers located in two adjacent rows are aligned in the second direction; and/or, the plurality of first spacers located in two adjacent rows are staggered in the second direction.

According to some exemplary embodiments, an orthographic projection of the first spacer on the first base has a first size in the first direction and a second size in the second direction, and a ratio of the second size to the first size is no less than 20.

According to some exemplary embodiments, an orthographic projection of the first spacer on the first base has a first size in the first direction and a second size in the second direction, and a ratio of the second size to the first size is no more than 5.

According to some exemplary embodiments, an orthographic projection of the second spacer on the first base has a third size in the first direction, and the first size is equal to the third size.

According to some exemplary embodiments, the first spacer has a first thickness in a third direction perpendicular to both the first direction and the second direction; the second spacer has a second thickness in the third direction; and the first thickness is equal to the second thickness.

According to some exemplary embodiments, an orthographic projection of the second spacer on the first base has a fourth size in the second direction, and the second size is equal to the fourth size.

According to some exemplary embodiments, the cushion layer structure includes a first cushion layer, and the first cushion layer is located on the same layer as the black matrix located in the display region or the color resistance portion.

According to some exemplary embodiments, the cushion layer structure includes the first cushion layer and a second cushion layer. The second cushion layer is located on a side of the first cushion layer facing the second substrate. The first cushion layer is located on the same layer as the black matrix located in the display region. The second cushion layer is located on the same layer as the color resistance portion located in the display region.

According to some exemplary embodiments, the first substrate further includes a cover layer located on a side of the color resistance portion facing the second substrate; and the cushion layer structure includes a first cushion layer, a second cushion layer and a third cushion layer. The second cushion layer is located on a side of the first cushion layer facing the second substrate. The third cushion layer is located on a side of the second cushion layer facing the second substrate. The first cushion layer is located on the same layer as the black matrix located in the display region. The second cushion layer is located on the same layer as the color resistance portion located in the display region. The third cushion layer is located on the same layer as the cover layer located in the display region.

According to some exemplary embodiments, an orthographic projection of the first cushion layer on the first base is spaced apart from an orthographic projection of the sealing adhesive on the first base.

According to some exemplary embodiments, an orthographic projection of the first cushion layer on the first base at least partially overlaps with an orthographic projection of the sealing adhesive on the first base.

According to some exemplary embodiments, the display panel further includes a groove between the first cushion layer and the black matrix located in the display region, and an orthographic projection of the groove on the first base falls within the orthographic projection of the sealing adhesive on the first base.

In another aspect, there is provided a display device including the display panel as described above.

### BRIEF DESCRIPTION OF THE DRAWINGS

The above content and other purposes, features, and advantages of the present disclosure will become clearer through the following description of the embodiments of the present disclosure with reference to the accompanying drawings, in which:

FIG. 1 is a schematic diagram of a principle of a liquid crystal display panel warping;

FIG. 2 is a schematic plan view of a display substrate according to some exemplary embodiments of the present disclosure;

FIG. 3 is a schematic cross-sectional view of a display panel according to some exemplary embodiments of the present disclosure;

FIG. 4 is a schematic partial cross-sectional view of a display panel according to some exemplary embodiments of the present disclosure;

FIG. 5 is a schematic plan view of a display panel according to some exemplary embodiments of the present disclosure, which schematically shows a positional relationship between spacers and a chip in the plan view;

FIG. 6 is a schematic diagram of a relationship between a first spacer and a first spacer wall of a display panel according to some exemplary embodiments of the present disclosure;

FIG. 7 is a schematic diagram of a distribution density of spacers of a display panel according to some exemplary embodiments of the present disclosure;

FIG. 8 is a schematic diagram of another distribution density of spacers of a display panel according to some exemplary embodiments of the present disclosure;

FIG. 9 is a schematic partial cross-sectional view of a display panel according to some other exemplary embodiments of the present disclosure;

FIG. 10 is a schematic plan view of a display panel according to some other exemplary embodiments of the present disclosure;

FIG. 11 is a schematic diagram of an arrangement of spacers of a display panel according to some other exemplary embodiments of the present disclosure;

FIG. 12 is a schematic diagram of an arrangement of spacer walls of a display panel according to some other exemplary embodiments of the present disclosure;

FIG. 13 is a schematic diagram of another distribution density of spacers of a display panel according to some other exemplary embodiments of the present disclosure;

FIG. 14 is a schematic diagram of another distribution density of spacers of a display panel according to some other exemplary embodiments of the present disclosure;

FIG. 15 is a schematic partial cross-sectional view of a display panel according to yet some exemplary embodiments of the present disclosure;

FIG. 16 is a schematic plan view of a display panel according to yet some exemplary embodiments of the present disclosure;

FIG. 17 is a schematic diagram of an arrangement of spacers of a display panel according to yet some exemplary embodiments of the present disclosure;

FIG. 18 is a schematic diagram of an arrangement of spacer walls of a display panel according to yet some exemplary embodiments of the present disclosure;

FIG. 19 is a schematic diagram of another distribution density of spacers of a display panel according to yet some exemplary embodiments of the present disclosure;

FIG. 20 is a schematic diagram of yet another distribution density of spacers of a display panel according to yet some exemplary embodiments of the present disclosure;

FIG. 21 is a statistical chart of effects between a display panel of an embodiment and a display panel of a comparative example according to some exemplary embodiments of the present disclosure; and

FIG. 22 is a statistical chart of effects between a display panel of an embodiment and a display panel of a comparative example according to some other exemplary embodiments of the present disclosure.

### DETAILED DESCRIPTION OF EMBODIMENTS

In order to make purposes, technical solutions, and advantages of embodiments of the present disclosure clearer, technical solutions in some embodiments of the present disclosure will be described clearly and completely in combination with accompanying drawings. Apparently, the described embodiments are only part of the embodiments of the present disclosure, not all of them. Based on the embodiments of the present disclosure provided, all other embodiments obtained by those of ordinary skilled in the art without creative labor, fall within scope of protection of the present disclosure.

It should be noted that, in the drawings, a size and a relative size of the elements may be exaggerated for clarity and/or description. In this way, a dimension and a relative dimension of the various elements are not necessarily limited to those shown in the drawings. In the specification and drawings, a same or similar reference number refer to a same or similar part.

When an element is described as being “on”, “connected to”, or “coupled to” another element, the element may be directly on, directly connected to, or directly coupled to the other element, or intermediate elements may exist. However, when an element is described as being “directly on”, “directly connected to”, or “directly coupled to” another element, there is no intermediate element. Other terms and/or expressions used to describe a relationship between elements will be interpreted in a similar manner, e.g., “between” versus “directly between”, “adjacent” versus “directly adjacent”, or “on” versus “directly on” etc. Furthermore, the term “connected” may refer to a physical connection, an electrical connection, a communication connection, and/or a fluid connection. In addition, an X axis, a Y axis and a Z axis are not limited to a three axes of a rectangular coordinate system, and may be interpreted in a broader sense. For example, the X, Y, and Z axes may be perpendicular to each other, or may represent different directions that are not perpendicular to each other. For the purposes of the present disclosure, “at least one of X, Y, and Z” and “at least one selected from the group formed by X, Y, and Z” may be interpreted as only X, only Y, only Z, or any combination of two or more of X, Y and Z such as XYZ, XYY, YZ and ZZ. As used herein, the term “and/or” includes any combination and all combinations of one or more of the listed associated items.

It should be noted that, although the terms “first”, “second”, etc. may be used herein to describe various components, members, elements, regions, layers and/or parts, these components, members, elements, regions, layers and/or parts will not be limited by these terms. Rather, these terms are used to distinguish one component, member, element, region, layer and/or part from another. Thus, for example, a first component, a first member, a first element, a first region, a first layer and/or a first part discussed below could be termed a second component, a second member, a second element, a second region, a second layer and/or a second part without departing from the teachings of the present disclosure.

For ease of description, a spatially relational term, e.g., “upper”, “lower”, “left”, “right”, etc. may be used herein to describe a relationship between one element or feature with another element or feature as shown in the drawings. It should be understood that the spatially relational term is intended to encompass other different orientations of the apparatus in use or operation in addition to an orientation depicted in the drawings. For example, if the apparatus in the drawings is turned over, the elements described as “below” or “beneath” the other elements or features would then be oriented “above” or “on” the other elements or features.

In this text, the terms “basically”, “about”, “approximately”, “roughly” and other similar terms are used as approximate terms rather than as terms of degree, and they are intended to explain the fixed deviation of measured or calculated values that will be recognized by those skilled in the art. Taking into account factors such as process fluctuations, measurement problems and errors related to the measurement of a specific amount (i.e., the limitations of the measurement system), the “about” or “approximately” used here includes the stated value, and indicates that the specific value determined by ordinary technicians in the art is within the acceptable deviation range. For example, “about” may be expressed within one or more standard deviations, or within ±30%, ±20%, ±10%, ±5% of the stated values.

It should be noted that the expression “same layer” refers to a layer structure which is formed by forming a layer used to form a specific pattern by the same film-forming process, and then patterning the layer by using the same mask through a one-time patterning process. According to the difference between the specific patterns, the one-time patterning process may include multiple exposures, developments or etching processes, and the specific pattern in the formed layer structure may be continuous or discontinuous. That is, multiple elements, components, structures and/or parts located in the “same layer” are made of the same material and formed by the same composition process. Generally, multiple elements, components, structures and/or parts located in the “same layer” have substantially the same thicknesses.

In the present disclosure, the functions of “source electrode” and “drain electrode” are sometimes interchanged in a case of using transistors with opposite polarities or in a case that the direction of current changes during circuit operation. Therefore, in the present disclosure, the “source electrode” and “drain electrode” may be interchanged.

In the present disclosure, “electrical connection” includes a case where the forming elements are directly connected, and it also includes a case where they are connected together through elements that have a certain electrical effect. As long as “elements that have a certain electrical effect” may control electrical signals between the forming elements that may be connected, there is no specific restrictions on it. Examples of “elements that have a certain electrical effect” include not only electrodes and wiring, but also include switching elements such as transistors, resistors, inductors, capacitors, and other elements with one or more functions.

In the present disclosure, “parallel” refers to a status that an angle formed by two straight lines is no less than 10° and no more than 10°, and therefore it may include a status that the angle is no less than 5° and no more than 5°. In addition, “vertical” refers to a status that the angle formed by two straight lines is no less than 80° and no more than 100°, and therefore it may include a status that the angle is no less than 85° and no more than 95°.

COG process refers to adding IC and leads to an LCD display screen, and using ACF to directly bond the IC to the LCD screen through hot pressing.

COG Mura phenomenon refers to the deformation and warping of glass substrate after a COG process due to differences in the thermal expansion coefficients of different materials. Therefore, in the operation of the liquid crystal display panel, an imperfect phenomenon displayed on a surface of a pixel matrix refers to a phenomenon of uneven visual effects caused by pixel differences due to local region near the driving chip in the liquid crystal display panel.

Gap problem refers to the liquid crystal display panel having a color film substrate and an array substrate, with a certain gap between the two substrates. The liquid crystal is filled in this gap, and a height of this gap is referred to as a thickness of a liquid crystal cell. When electricity is applied to electrodes of the two substrates, voltage is applied to the liquid crystal through the electrodes on the two substrates, changing an arrangement of liquid crystal molecules, thereby achieving image display. However, due to deformation and warping of the array substrate (glass substrate), the thickness of the liquid crystal cell is uneven, thereby resulting in uneven brightness of the liquid crystal display panel.

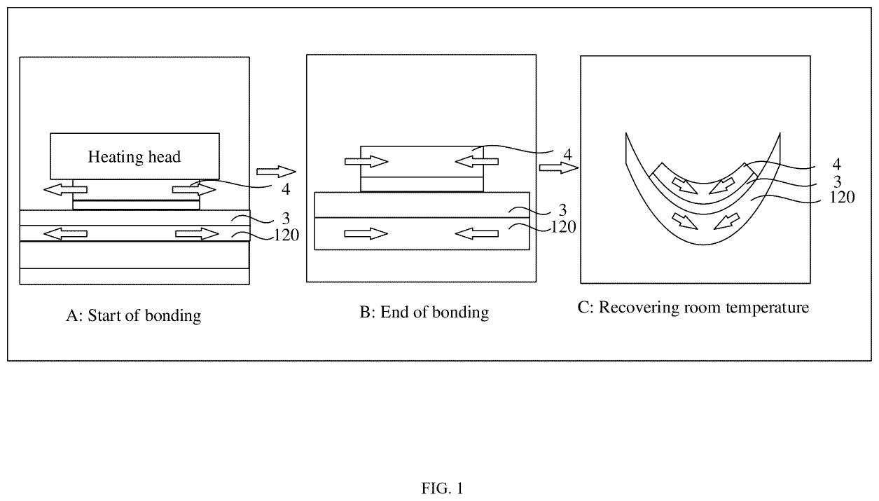

FIG. 1 is a schematic diagram of a principle of a liquid crystal display panel warping. With reference to FIG. 1, in ultra-thin and ultra-narrow border products, the COG Mura problem greatly restricts the display effect of products. Since a distance between the driving chip (IC) and the display region AA is small, the COG Mura phenomenon may occur after the COG process. As a resolution of the display product continues to improve, the distance between the driving chip and the display region decreases, and the impact of deformation on the display region increases. The driving chip is bonded on the glass substrate through ACF. During hot pressing, the driving chip is pressed towards a side close to the glass substrate using a hot pressing tool. At this time, the driving chip, the ACF and the glass substrate are deformed under pressure. At the end of hot pressing, due to the thermal expansion of the driving chip, the ACF and glass substrate, a thickness of the driving chip, ACF and glass substrate increases. When a temperature of the driving chip, ACF and glass substrate recovers to room temperature, due to the difference in thermal expansion coefficients of different materials, a shrinkage of the driving chip is greater than that of the glass substrate, causing the glass substrate to preferentially deform and warp, thereby causing the display panel to warp. The phenomenon of warping causes the orientation of the liquid crystal near the driving chip region to slightly change, affecting a polarization direction of an emitted light to be not completely perpendicular to a polarization direction of an upper load point power supply, resulting in light leakage (that is COG Mura) of the display panel.

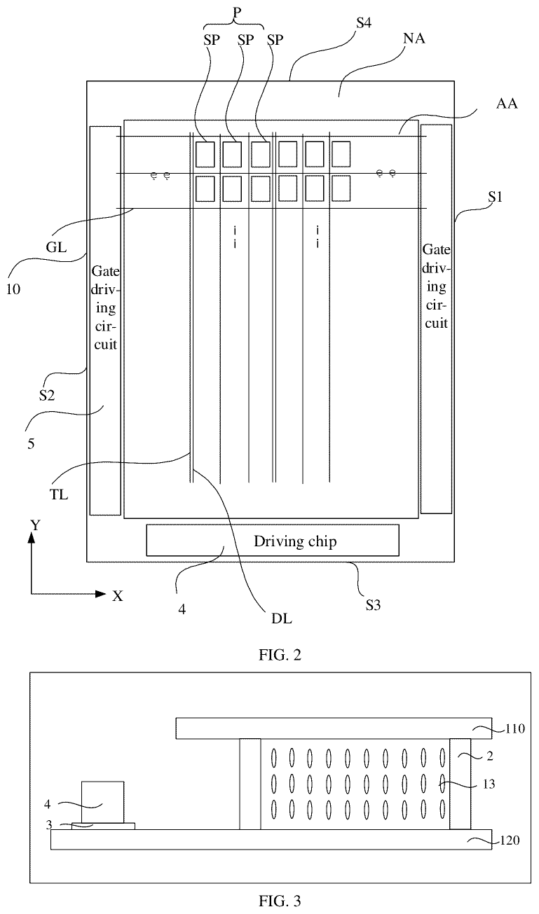

FIG. 2 is a schematic diagram of a display substrate. With reference to FIG. 2, the display substrate in this embodiment includes a display region AA and a peripheral region NA that at least partially surrounds the display region AA. The display substrate may include a first side S1, a second side S2, a third side S3, and a fourth side S4. The first side S1 and the second side S2 may be disposed opposite to each other, and the third side S3 and the fourth side S4 may be disposed opposite to each other. For example, in the embodiment shown in FIG. 1, the first side S1 and the second side S2 may be a right side and a left side of the display substrate, respectively, and the third side S3 and the fourth side S4 may be a lower side and an upper side of the display substrate, respectively.

It should be noted that the left, right, upper and lower sides here may refer to the left, right, upper, and lower sides of the display substrate (screen) viewed by the human eye during display.

With continued reference to FIG. 1, the display substrate may include a gate driving circuit 5 and a driving chip 4 located in the peripheral region NA. For example, the gate driving circuit 5 may be located on at least one side of the display substrate. In the embodiment shown in FIG. 1, the gate driving circuit 5 may be located on the first side S1 and the second side S2 of the display substrate, respectively. For example, the driving chip 4 may be located on at least one side of the display region AA. In the embodiment shown in FIG. 1, the driving chip 4 is located on the third side S3 of the display substrate.

The gate driving circuit 5 may be implemented by a shift register, and the gate driving circuit 5 may provide scanning signals to various gate lines GL on the display substrate. The driving chip 4 may include a data driving circuit, and the data driving circuit may provide data signals to various data lines DL on the display substrate.

It should be noted that, although the gate driving circuit 5 is shown on the left side and the right side of the display region and the driving chip 4 is located on the lower side of the display region AA in FIG. 1, the embodiments of the present disclosure are not limited to this, and the gate driving circuit 5 and the driving chip 4 may be located at any suitable position in the peripheral region NA.

For example, the gate driving circuit 5 may adopt GOA technology, that is, Gate Driver on Array. In GOA technology, the gate driving circuit 5 is directly disposed on the array substrate to replace an external chip. Each GOA unit serves as a stage of shift register, each shift register is connected to one gate line. Through sequentially outputting scanning signals by various stages of shift registers in turn, pixel units are scanned row by row. In some embodiments, each shift register may also be connected to a plurality of gate lines. In this way, it may adapt to the development trend of high-resolution and narrow border of the display substrate.

The display substrate may further include a second base 110 and a plurality of pixel units P disposed on the second base 110 and located in the display region AA. The plurality of pixel units P are arranged in an array in the second direction X and the first direction Y, and the second direction X intersects with the first direction Y. For example, the second direction X is a horizontal direction in FIG. 1, and the first direction Y is a vertical direction in FIG. 1, that is, the second direction X and the first direction Y are perpendicular to each other.

At least one pixel unit P includes a plurality of sub-pixels SP, and the plurality of sub-pixels SP may display different colors through corresponding color films. For example, the plurality of sub-pixels SP in a pixel unit P may include a first sub-pixel, a second sub-pixel and a third sub-pixel. The first sub-pixel may be matched with a red color film to display red light, the second sub-pixel may be matched with a green color film to display green light, and the third sub-pixel may be matched with a blue color film to display blue light.

It should be noted that FIG. 2 exemplarily shows that a shape of an orthographic projection of a sub-pixel on a base substrate is in a shape of rectangle, but the embodiments of the present disclosure are not limited to this. Moreover, the arrangement of three sub-pixels in a pixel unit P is not limited to the arrangement shown in FIG. 2.

The display substrate may further include a plurality of data lines DL and a plurality of gate lines GL arranged on the second base 10. With reference to FIG. 1, at least one of the plurality of data lines DL may extend from the fourth side S4 to the third side S3, thereby being electrically connected to the driving chip 4 located on the third side S3. At least one of the plurality of data lines DL may extend from the first side S1 to the second side S2, thereby being electrically connected to the gate driving circuit 5 located on the first side S1 or the second side S2.

In the embodiments of the present disclosure, the plurality of data lines DL are arranged at intervals in the second direction X, for example, the plurality of data lines DL are electrically connected to a plurality of columns of sub-pixels SP respectively. The plurality of gate lines GL are arranged at intervals in the first direction Y, for example, the plurality of gate lines GL are electrically connected to a plurality of rows of sub-pixels SP respectively.

FIG. 3 is a schematic cross-sectional view of a display panel 100. With reference to FIG. 3, the display panel 100 may include a display substrate and a sealing adhesive 2. For example, the display panel 100 may include a first substrate, a second substrate, and a liquid crystal layer 13. The first substrate may include a first base 110 and a color film element disposed on the first base 110. That is, the first substrate may be a color film substrate. The second substrate may have a structure of the display substrate described above. On this basis, the second substrate may include a second base 120, the first base 110 is disposed opposite to the first base 110, the second base 120 is located below the first base 110, and the liquid crystal layer 13 is sandwiched between the first base 110 and the second base 120. The driving chip 4 is disposed on the second base 120 through an anisotropic conductive film 3. The sealing adhesive 2 surrounds a periphery of the liquid crystal layer 13, and the sealing adhesive 2 is located between the first base 110 and the second base 120.

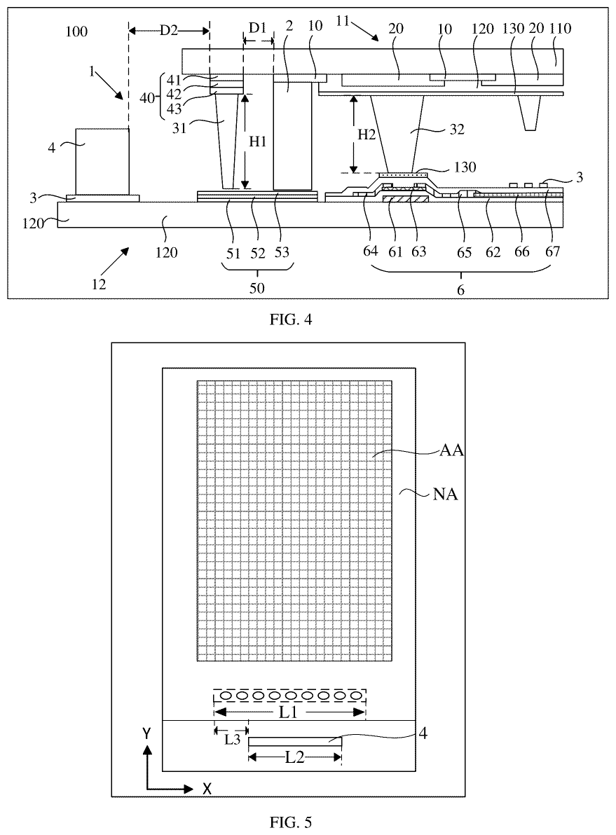

FIG. 4 is a schematic cross-sectional view of a display panel 100 according to some exemplary embodiments of the present disclosure. With reference to FIG. 3 and FIG. 4, the embodiments of the present disclosure provide a display panel 100, and the display panel 100 includes a display region AA and a peripheral region NA. The peripheral region NA at least partially surrounds the display region AA, and the peripheral region NA includes a third side. The display panel 100 includes a first substrate 11, where the first substrate 11 includes a first base 110; and a black matrix 10 and a plurality of color resistance portions 20 disposed on the first base 110, where the plurality of color resistance portions 20 are arranged in an array in the first direction and the second direction in the display region AA; and a plurality of spacers disposed on the first base 110, where the plurality of spacers include a first spacer 31 located in a first sub peripheral region (for example, a part of the peripheral region on the third side) and a second spacer 32 located in the display region AA; a second substrate 12 arranged opposite to the first substrate 11, where the second substrate 12 includes: a second base 120; a plurality of pixel driving circuits 6 disposed on the second base 120, where the plurality of pixel driving circuits 6 are arranged in an array in the first direction and the second direction in the display region AA; and a driving chip 4 disposed on the second base 120, where the driving chip 4 is located in the first sub peripheral region; and a sealing adhesive 2, where the sealing adhesive 2 is located between the first substrate 11 and the second substrate 12, and the sealing adhesive 2 surrounds the display region AA, where the first spacer 31 is located on a side of the sealing adhesive 2 away from the display region AA, the first spacer 31 is located between the sealing adhesive 2 and the driving chip 4 in the first direction, and the first direction is a direction pointing from a center of the display region AA to the driving chip 4; and where the display panel 100 further includes a cushion layer structure 40 disposed on the first base 110, and the first spacer 31 is located on a side of the cushion layer structure 40 facing the second substrate 12. In the embodiments of the present disclosure, by coordinating the cushion layer structure 40 and the first spacer 31 disposed in the first sub peripheral region, effective support is formed between the first substrate 11 and the second substrate 12, which has a certain buffering function, thereby causing the second substrate 12 to be less prone to deformation and warping after the COG process. In this case, through disposing a cushion layer structure 40, it may reduce a difference between a segment between one end of the first spacer 31 and the first substrate 11 and a segment between the other end of the first spacer 31 and the second substrate 12, so that the buffering effect of the first spacer 31 between the first substrate 11 and the second substrate 12 may be better.

FIG. 5 is a schematic plan view of a display panel 100 according to some exemplary embodiments of the present disclosure. With reference to FIG. 4 and FIG. 5, the display panel 100 includes a display region AA and a peripheral region NA, where the peripheral region NA at least partially surrounds the display region AA. The peripheral region NA includes a first side S1, a second side S2, a third side S3, and a fourth side S4. The first side S1 and the second side S2 may be disposed opposite to each other, and the third side S3 and the fourth side S4 may be disposed opposite to each other. For example, in the embodiment shown in FIG. 4, the first side S1 and the second side S2 may be a right side and a left side of the display panel 100 respectively, and the third side S3 and the fourth side S4 may be a lower side and an upper side of the display panel 100 respectively

The display panel 100 may include a cushion layer structure 40 disposed on the first base 110. The first spacer 31 is located on a side of the cushion layer structure 40 facing the second substrate 12.

Specifically, the plurality of color resistance portions 20 include a red sub-pixel, a green sub-pixel, and a blue sub-pixel. A plurality of black matrices 10 are provided. Some black matrices 10 are arranged in an array in the first direction and the second direction in the display region AA, and the black matrix 10 is disposed between two adjacent sub-pixels; while others are disposed in the peripheral region NA and arranged along the periphery of the display region AA. The sealing adhesive 2 is disposed on a side of the black matrix 10 close to the second base 120.

For example, the plurality of color resistance portions 20 may include a color resistance portion of red sub-pixel, a color resistance portion of green sub-pixel, a color resistance portion of blue sub-pixel, and/or a color resistance portion of white sub-pixel. The black matrix 10 is disposed between two adjacent sub-pixels.

In the embodiments of the present disclosure, the first substrate 11 further includes a cover layer 120 located on a side of the color resistance portion 20 facing the second substrate 12. The cover layer 120 is coated with a negative photoresist material on the color resistance portion 20, and a passivation layer 130 is provided on a side of the cover layer 120 close to the second base 120.

For example, the passivation layer 130 may be manufactured using inorganic materials such as SiO₂ or Si₃N₄, or organic materials such as PI (polyimide) or BCB (benzocyclobutene). For example, in the embodiments of the present disclosure, the passivation layer 130 may be manufactured using PI.

It should be noted that there is no specific limitation on the material of the passivation layer 130 in the embodiments of the present disclosure, and the above materials may be selected to manufacture the passivation layer 130 according to actual manufacturing cases.

In some exemplary embodiments, the cushion layer structure 40 may include a first cushion layer 41. The first cushion layer 41 is located on the same layer as the black matrix 10 or the color resistance portion 20 located in the display region AA.

In some other exemplary embodiments, the cushion layer structure 40 may include a first cushion layer 41 and a second cushion layer 42. The second cushion layer 42 is located on a side of the first cushion layer 41 facing the second substrate 12, the first cushion layer 41 is located on the same layer as the black matrix 10 located in the display region AA, and the second cushion layer 42 is located on the same layer as the color resistance portion 20 located in the display region AA.

In some exemplary embodiments, the cushion layer structure 40 may further include a first cushion layer 41, a second cushion layer 42 and a third cushion layer 43. The second cushion layer 42 is located on a side of the first cushion layer 41 facing the second substrate 12, and the third cushion layer 43 is located on a side of the second cushion layer 42 facing the second substrate 12. The first cushion layer 41 is located on the same layer as the black matrix 10 located in the display region AA, the second cushion layer 42 is located on the same layer as the color resistance portion 20 located in the display region AA, and the third cushion layer 43 is located on the same layer as the cover layer 120 located in the display region AA.

Specifically, the first cushion layer 41 is a black matrix 10, the second cushion layer 42 is a color resistance layer, and the third cushion layer 43 is a planarization layer. The black matrix 10 connected to the spacer is located on the same layer as the black matrix 10 in the display region AA, the color resistance layer is located on the same layer as the color resistance portion 20, and the planarization layer is located on the same layer as the cover layer 120. The color resistance layer may use any one of the color resistance portion of red sub-pixel, the color resistance portion of green sub-pixel, the color resistance portion of blue sub-pixel, and the color resistance portion of white sub-pixel. The third cushion layer 43 is coated with a negative photoresist material on a surface of the second cushion layer 42. A width of the first cushion layer 41, a width of the second cushion layer 42, and a width of the third cushion layer 43 in the first direction are equal.

It should be noted that in the embodiments of the present disclosure, it is possible to select any one of the black matrix 10 and the color resistance layer in the cushion structure 40, or a combination of the black matrix 10 and the color resistance layer. However, the embodiments of the present disclosure do not specifically limit the combination relationship of the black matrix 10, the color resistance layer and the planarization layer.

It may be understood that through the combination relationship of the first cushion layer 41, the second cushion layer 42, and the third cushion layer 43 in the cushion structure 40, a gap between the first spacer 31 and the second base 120 may be reduced, thereby forming better support between the first substrate 11 and the second substrate 12, suppressing the warping of the second substrate 12, while improving the gap problem of the display panel 100.

In some embodiments of the present disclosure, an orthographic projection of the first cushion layer 41 on the first base 110 is spaced apart from an orthographic projection of the sealing adhesive 2 on the first base 110.

Specifically, in the peripheral region NA, the black matrix 10 connected to the first spacer 31 is spaced apart from the black matrix 10 connected to the sealing adhesive 2, and the two black matrices 10 are discontinuously disposed. The discontinuously disposed black matrix 10 may ensure that ESD (that is electrostatic discharge) does not enter the display region AA. The cover layer 120 and the passivation layer 130 protrude from the display region AA, and a side of the black matrix 10 connected to the sealing adhesive 2 close to the display region AA is located in the cover layer 120.

In some other exemplary embodiments of the present disclosure, an orthographic projection of the first cushion layer 41 on the first base 110 at least partially overlaps with an orthographic projection of the sealing adhesive 2 on the first base 110.

In the embodiments of the present disclosure, an orthographic projection of the first spacer 31 on the first base 110 falls within an orthographic projection of the cushion structure 40 on the first base 110.

Specifically, a side of the first spacer 31 close to the driving chip 4 and perpendicular to the first direction does not protrude from the first cushion layer 41, and a width of the first spacer 31 in the first direction is less than a width of the cushion layer structure 40 in the first direction. For example, in the embodiments of the present disclosure, a vertical cross-section of the first spacer 31 is in a shape of inverted trapezoid, and a cross-sectional area of an end of the first spacer 31 close to the second base 120 is less than a cross-sectional area of an end of the first spacer 31 close to the first base 110.

It should be noted that a shape of the vertical cross-section of the first spacer 31 in the embodiments of the present disclosure may also be a rectangle. However, the shape of the first spacer 31 is not specifically limited in the embodiments of the present disclosure.

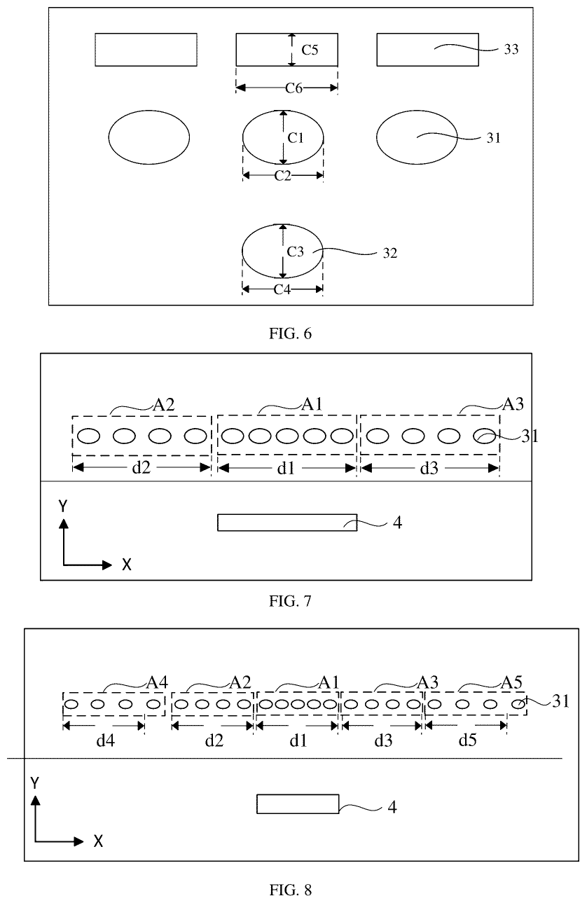

FIG. 6 is a schematic diagram of a relationship between a spacer and a spacer wall of a display panel according to some exemplary embodiments of the present disclosure. With reference to FIG. 4 to FIG. 6, in the embodiments of the present disclosure, the display panel 100 includes a plurality of first spacers 31. The plurality of first spacers 31 are located between the sealing adhesive 2 and the driving chip 4 in the first direction. The plurality of first spacers 31 are distributed at intervals in the second direction, and the second direction is perpendicular to the first direction. For example, the first direction may be a Y direction, and the second direction may be an X direction.

The plurality of first spacers 31 are arranged in one row in the first direction, and the plurality of first spacers 31 located in the row are arranged at equal intervals in the second direction.

Due to the influence of a temperature field around the driving chip 4, a size L1 of a region in which the plurality of first spacers 31 are distributed in the second direction is greater than a size L2 of the driving chip 4 in the second direction.

Specifically, a length L1 of the region in which the first spacers 31 are distributed in the second direction is greater than a length L2 of the driving chip 4 in the second direction, and a length of the display region AA in the second direction is greater than a length of the first spacers 31 in the second direction.

For example, a center of the region in which the plurality of first spacers 31 are distributed and a center of the driving chip 4 are located on an axis laid along the first direction. Two ends of the region in which the plurality of first spacers 31 are distributed respectively protrude from two ends of the driving chip 4 at equal distances. The size L2 of the driving chip 4 in the second direction is in a range of 30 μm to 35 μm, and the size L1 of the region in which the plurality of first spacers 31 are distributed in the second direction is in a range of 42 μm to 49 μm. When the size L1 of the driving chip 4 in the second direction is 30 μm, the size L1 of the region in which the plurality of first spacers 31 are distributed is 42 μm in the second direction. When the size L2 of the driving chip 4 in the second direction is 35 μm, the size L1 of the region in which the plurality of first spacers 31 are distributed in the second direction is 49 μm. A distance between an end of the region in which the plurality of first spacers 31 are distributed and an end of the driving chip 4 located on the same side of the plurality of first spacers 31 is an influence distance L3, and a length of the influence distance L3 is 20% of the size of the driving chip 4 in the second direction.

It should be noted that an influence range of a temperature field of a periphery of the driving chip 4 is 20% of the length of the driving chip 4 (that is a second direction size). For example, a length of the driving chip 4 is in a range of 30 mm to 35 mm. FIG. 5 defines a range of a heat influence region of the driving chip as a range corresponding to L1, where a value of L1 is the length of the driving chip extended 20% to the left and right respectively. This region is the influence region of the driving chip on the glass substrate after bonding, that is, a warpage range. In the embodiments of the present disclosure, an effective support position of the first spacer has a length located within the heat influence region of the driving chip in the X direction, thereby effectively improving an effect of warping. In some embodiments of the present disclosure, the first spacer 31 is spaced apart from the sealing adhesive 2 in the first direction, a minimum interval distance between the first spacer 31 and the sealing adhesive 2 in the first direction is a first interval distance D1, the first spacer 31 is spaced apart from the driving chip 4 in the first direction, a minimum interval distance between the first spacer 31 and the driving chip 4 in the first direction is a second interval distance D2, and the first interval distance D1 is less than the second interval distance D2.

In other embodiments of the present disclosure, an orthographic projection of the first spacer 31 on the first base 110 has a first size C1 in the first direction and a second size in the second direction, and a ratio of the second size to the first size C1 is no more than 5.

For example, the first size C1 of the first spacer 31 may be 9.5 μm. The embodiments of the present disclosure do not specifically limit the first size C1 and the second size, as long as the ratio of the second size to the first size C1 is no more than 5.

In some other embodiments of the present disclosure, the display panel 100 includes a plurality of first spacer walls 33. The plurality of first spacer walls 33 are connected in the second direction, so as to form a spacer wall. The plurality of first spacer walls 33 are arranged in one row in the first direction, and the plurality of first spacer walls 33 located in the row are arranged at equal intervals in the second direction. The plurality of first spacer walls 33 are located between the sealing adhesive 2 and the driving chip 4 in the first direction, and the plurality of first spacer walls 33 are spaced apart in the second direction. The second direction is perpendicular to the first direction.

Due to the influence of the temperature field of the periphery of the driving chip 4, a size L1 of the region in which the plurality of first spacer walls 33 are distributed in the second direction is greater than a size L2 of the driving chip 4 in the second direction.

Specifically, a length L1 of the region in which the first spacer walls 33 are distributed in the second direction is greater than a length L2 of the driving chip 4 in the second direction, and a length of the display region AA in the second direction is greater than a length of the first spacers 31 in the second direction.

For example, a center of the region in which the plurality of first spacer walls 33 are distributed and a center of the driving chip 4 are located on an axis laid along the first direction. Two ends of the region in which the plurality of first spacer walls 33 are distributed respectively protrude from two ends of the driving chip 4 at equal distances. The size L2 of the driving chip 4 in the second direction is in a range of 30 μm to 35 μm, and the size of the region in which the plurality of first spacer walls 33 are distributed in the second direction is in a range of 42 μm to 49 μm. When the size of the driving chip 4 in the second direction is 30 μm, the size of the region of the plurality of first spacer walls 33 in the second direction is 42 μm. When the size of the driving chip 4 in the second direction is 35 μm, the size of the plurality of first spacer walls 33 in the second direction is 49 μm. A distance between an end of the region of the plurality of first spacer walls 33 and an end of the driving chip 4 located on the same side is an influence distance L3, and a length of the influence distance L3 is 20% of the size of the driving chip 4 in the second direction.

In some embodiments of the present disclosure, the first spacer wall 33 is spaced apart from the sealing adhesive 2 in the first direction, a minimum interval distance between the first spacer wall 33 and the sealing adhesive 2 in the first direction is a first interval distance D1, the first spacer wall 33 is spaced apart from the driving chip 4 in the first direction, a minimum interval distance between the first spacer wall 33 and the driving chip 4 in the first direction is a second interval distance D2, and the first interval distance D1 is less than the second interval distance D2.

In some embodiments of the present disclosure, an orthographic projection of the first spacer wall 33 on the first base 110 has a first size C5 in the first direction and a second size C6 in the second direction. A ratio of the second size to the first size C1 is no less than 20.

For example, the first size C5 of the first spacer wall 33 may be 9.5 μm, and the second size C6 may be 300 μm. The embodiments of the present disclosure do not specifically limit the size of the first size C5 and the size of the second size C6, as long as the ratio of the second size C6 to the first size C5 is no less than 20.

FIG. 7 is a schematic diagram of another distribution density of spacers of a display panel according to some exemplary embodiments of the present disclosure. In some embodiments of the present disclosure, with reference to FIG. 7, a region in which the plurality of first spacers 31 are distributed include a first sub-region A1, a second sub-region A2, and a third sub-region A3. The second sub-region A2 and the third sub-region A3 are located on two sides of the first sub-region A1 in the second direction, and the first sub-region A1 is directly opposite to the driving chip 4 in the first direction. The plurality of first spacers 31 have a first distribution density in the first sub-region A1. The plurality of first spacers 31 have a second distribution density in the second sub-region A2. The plurality of first spacers 31 have a third distribution density in the third sub-region A3. The first distribution density is greater than the second distribution density, and the first distribution density is greater than the third distribution density.

In some exemplary embodiments of the present disclosure, a ratio of a size of the second sub-region A2 in the second direction to a size of the first sub-region A1 in the second direction is between 0.1 and 0.4.

In some exemplary embodiments of the present disclosure, a ratio of a size of the third sub-region A3 in the second direction to the size of the first sub-region A1 in the second direction is between 0.1 and 0.4.

For example, when the size of the driving chip 4 in the second direction is 30 μm, the size of the first sub-region A1 in the second direction may be 30 μm, the size of the second sub-region A2 in the second direction may be 3 μm, and the size of the third sub-region A3 in the second direction may be 3 μm. When the size of the driving chip 4 in the second direction is 30 μm, the size of the first sub-region A1 in the second direction may be 30 μm, the size of the second sub-region A2 in the second direction may be 0.12 μm, and the size of the third sub-region A3 in the second direction may be 0.12 μm.

Specifically, the second distribution density is equal to the third distribution density.

It should be noted that the size of the third sub-region A3 in the second direction may be or may not be equal to the size of the second sub-region A2 in the second direction. The embodiments of the present disclosure do not specifically limit whether the size of the third sub-region A3 in the second direction is equal to the size of the second sub-region A2 in the second direction.

FIG. 8 is a schematic diagram of another distribution density of spacers of a display panel according to some exemplary embodiments of the present disclosure. With reference to FIG. 8, in some other embodiments of the present disclosure, the region in which the plurality of first spacers 31 are distributed further includes a fourth sub-region A4 and a fifth sub-region A5. The fourth sub-region A4 is located on a side of the second sub-region A2 away from the first sub-region A1 in the second direction, and the fifth sub-region A5 is located on a side of the third sub-region A3 away from the first sub-region A1 in the second direction. The plurality of first spacers 31 have a fourth distribution density in the fourth sub-region A4, the plurality of first spacers 31 have a fifth distribution density in the fifth sub-region A5, the second distribution density is greater than the fourth distribution density, and the third distribution density is greater than the fifth distribution density.

Specifically, a size of the fourth sub-region A4 in the second direction is equal to a size of the fifth sub-region A5 in the second direction. The fourth distribution density is equal to the fifth distribution density.

A spacing between two adjacent first spacers 31 located in the influence distance L3 and the first sub-region Al is in a range of 10 μm to 50 μm, and a spacing between two adjacent first spacers 31 located outside two influence distances L3 is greater than 50 μm.

In some embodiments of the present disclosure, an orthographic projection of the second spacer 32 on the first base 110 has a third size C3 in the first direction, where the first size C1 is equal to the third size C3.

In some embodiments of the present disclosure, an orthographic projection of the second spacer 32 on the first base 110 has a fourth size in the second direction, where the second size C2 is equal to the fourth size C4.

In some embodiments of the present disclosure, the first spacer 31 has a first thickness H1 in a third direction, and the third direction is perpendicular to both the first direction and the second direction. The second spacer 32 has a second thickness H2 in the third direction, and the first thickness H1 is equal to the second thickness H2.

For example, the first spacer 31 located in the peripheral region NA and the second spacer 32 located in the display region AA have the same size and are arranged in parallel in the first direction.

With continued reference to FIG. 4, a support structure 50 is provided on a side of the second base 120 close to the first base 110, and the support structure 50 is located in the peripheral region NA.

In some embodiments of the present disclosure, an orthographic projection of the first spacer 31 on the first base 110 falls within an orthographic projection of the support structure 50 on the first base 110. The support structure 50 is located on a side of the first spacer 31 close to the second base 120.

By the support structure 50, the gap between the first spacer 31 and the second base 120 may be further reduced, thereby providing better support between the first substrate 11 and the second substrate 12, suppressing the warping of the second substrate 12, and improving the gap problem of the display panel 100.

The support structure 50 may include a first support layer 51, a second support layer 52, and a third support layer 53. For example, the first support layer 51 may be a non-metallic protective layer, the second support layer 52 may be a non-metallic protective layer, and the third support layer 53 may also be a non-metallic protective layer. The second support layer 52 is located on a side of the first support layer 51 close to the first base 110, and the third support layer 53 is located on a side of the second support layer 52 close to the first base 110.

A pixel driving circuit 6 is provided on a side of the second base 120 close to the first base 110. The pixel driving circuit 6 is located in the display region AA. The pixel driving circuit 6 includes a gate 61 disposed on the second base 120; a gate insulation layer 62 located on a side of the gate 61 away from the second base 120; an active layer 63 located on a side of the gate insulation layer 62 away from the second base 120; a source 64 and a drain 65 located on a side of the active layer 63 away from the second base 120; where the source 64 and the drain 65 are respectively arranged on two sides of the active layer 63, a side of the source 64 away from the active layer 63 is connected to the gate insulation layer 62, and a side of the drain electrode 65 away from the active layer 63 is connected to the gate insulation layer 62, the source 64 is disposed close to a side of the driving chip 4, and the drain 65 is disposed on a side away from the driving chip 4; a second non-metallic protective layer 52 disposed on a side of the source 64 and the drain 65 away from the second base 120; a passivation layer 130 disposed on a side of the second non-metallic protective layer 52 away from the second base 120; a first conductive electrode 66 disposed on a side of the drain electrode 65 away from the source 64, where the first conductive electrode 66 is located between the second non-metallic protective layer 52 and the gate insulation layer 62; and a second conductive electrode 67 disposed on a side of the second non-metallic protective layer 52 away from the second base 120.

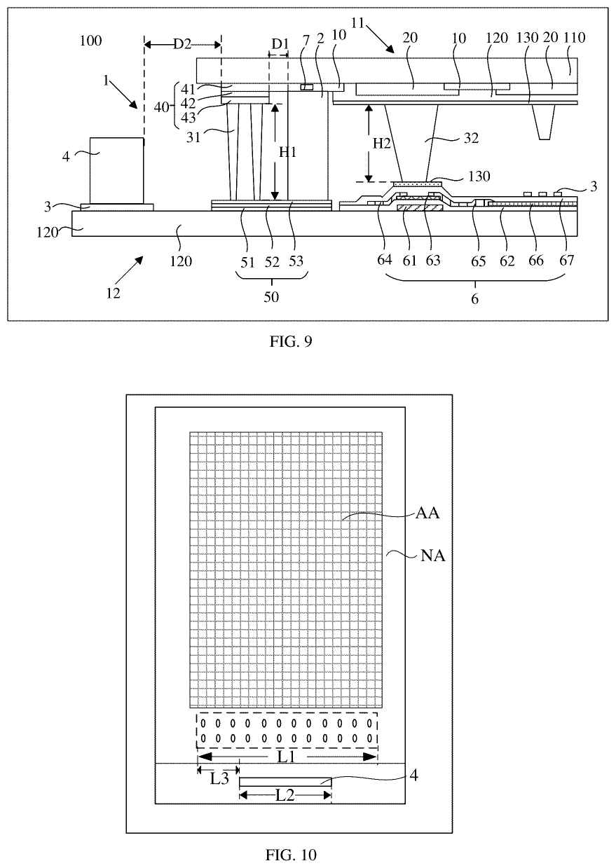

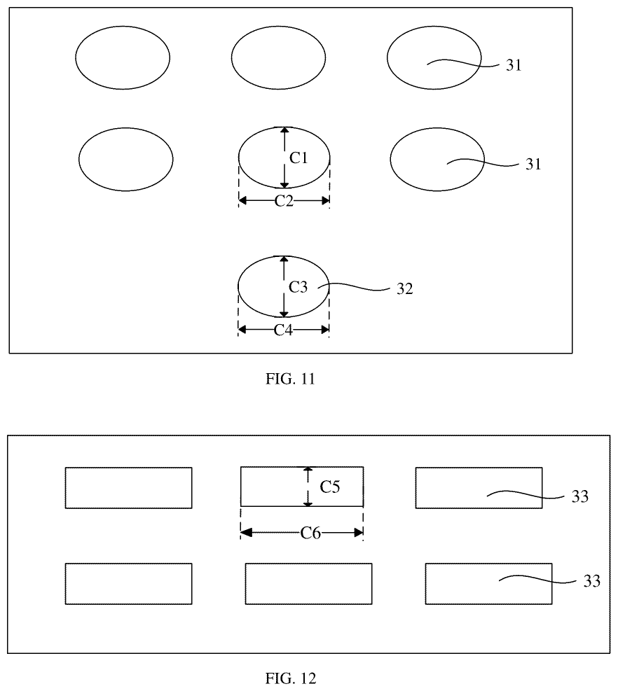

FIG. 9 is a schematic cross-sectional view of a display panel according to some other exemplary embodiments of the present disclosure. FIG. 10 is a front view of a display panel according to some other exemplary embodiments of the present disclosure. FIG. 11 is a schematic diagram of an arrangement of spacers of a display panel according to some other exemplary embodiments of the present disclosure. It should be noted that in the following text, the differences between the embodiments shown in FIG. 9 to FIG. 11 and the above embodiments will be mainly described. The similarities between the embodiments shown in FIG. 9 to FIG. 11 and the above embodiments will not be repeated, which may be referred to the detailed descriptions for the above embodiments.

With reference to FIG. 9, FIG. 10 and FIG. 11, in the embodiments of the present disclosure, the display panel 100 includes a plurality of first spacers 31, and the plurality of first spacers 31 are arranged in a plurality of rows of spacers in the first direction. The plurality of first spacers 31 located in the same row are arranged at equal intervals in the second direction.

In the embodiments of the present disclosure, the plurality of first spacers 31 located in two adjacent rows are aligned in the second direction.

For example, two rows of spacers are taken as an example for explanation. Regions in which the two rows of first spacers 31 are distributed have the same size in the second direction, and the plurality of first spacers 31 in each row correspond to each other one by one.

As shown in FIG. 9, the display panel 100 further includes a groove 7. The groove 7 is located between the first cushion layer 41 and the black matrix 10 located in the display region AA. An orthographic projection of the groove 7 on the first base 110 falls within an orthographic projection of the sealing adhesive 2 on the first base 110.

Specifically, the black matrix 10 connected to the first spacer 31 in the peripheral region NA and the black matrix 10 connected to the sealing adhesive 2 are continuously arranged, and the groove 7 is provided on the continuous black matrix 10, so as to ensure that ESD does not enter the display region AA.

FIG. 12 is a schematic diagram of an arrangement of spacer walls of a display panel according to some other exemplary embodiments of the present disclosure. With reference to FIG. 12, the display panel 100 may further include a plurality of rows of first spacer walls 33. The plurality of rows of first spacer walls 33 are arranged in a plurality of rows of spacers in the first direction. The plurality of first spacer walls 33 located in the same row are arranged at equal intervals in the second direction. Each first spacer wall 33 includes a plurality of first spacers 31. The plurality of first spacers 31 are connected in the second direction to form the first spacer wall 33.

In the embodiments of the present disclosure, the plurality of first spacer walls 33 located in two adjacent rows are aligned in the second direction. Two rows of spacers are taken as an example for explanation. Regions in which the two rows of first spacer walls 33 are distributed have the same size in the second direction, and the plurality of first spacer walls 33 in each row correspond to each other one by one.

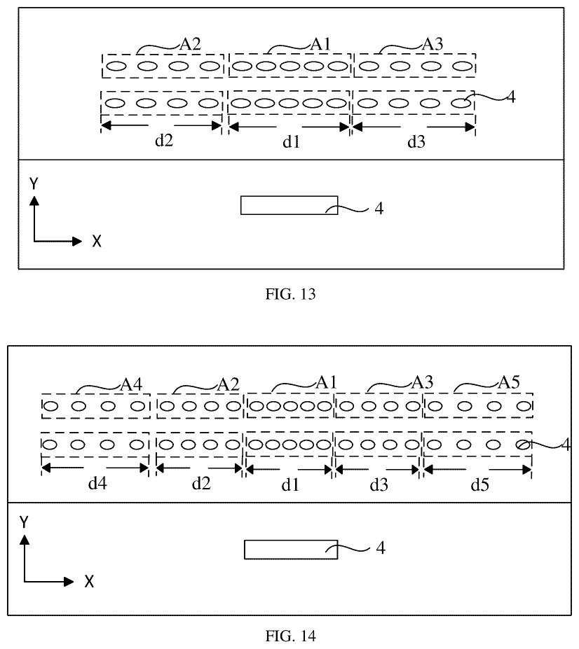

FIG. 13 is a schematic diagram of another distribution density of spacers of a display panel according to some other exemplary embodiments of the present disclosure. FIG. 14 is a schematic diagram of another distribution density of spacers of a display panel according to some other exemplary embodiments of the present disclosure. With reference to FIG. 13 and FIG. 14, two rows of spacers are schematically shown in the figures, and the distribution density of each row of spacers is the same as the distribution method of the single row of spacers as described above.

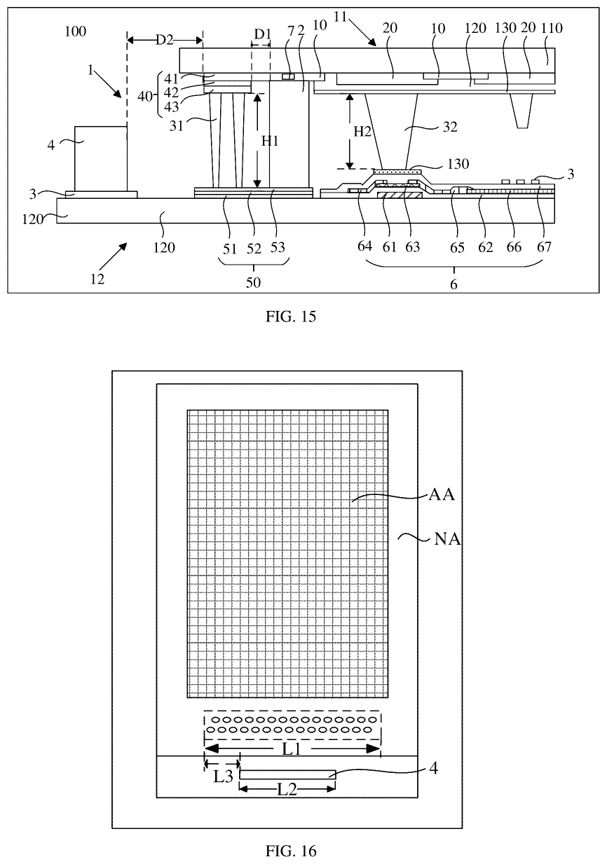

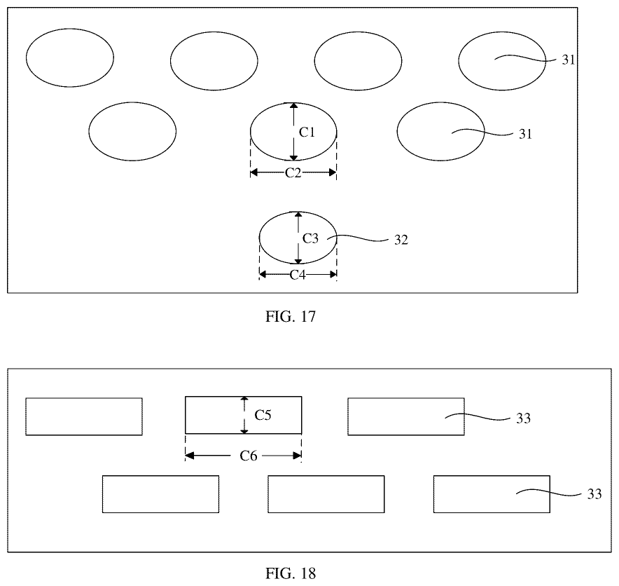

FIG. 15 is a schematic cross-sectional view of a display panel according to yet some exemplary embodiments of the present disclosure. FIG. 16 is a front view of a display panel according to yet some exemplary embodiments of the present disclosure. FIG. 17 is a schematic diagram of an arrangement of spacers of a display panel according to yet some exemplary embodiments of the present disclosure. It should be noted that in the following text, the differences between the embodiments shown in FIG. 15 to FIG. 17 and the above embodiments will be mainly described. The similarities between the embodiments shown in FIG. 15 to FIG. 17 and the above embodiments will not be repeated, which may be referred to the detailed descriptions for the above embodiments.

In the embodiments of the present disclosure, with reference to FIG. 15, FIG. 16 and FIG. 17, the display panel 100 includes a plurality of first spacers 31. The plurality of first spacers 31 are arranged in a plurality of rows of spacers in the first direction. The plurality of first spacers 31 located in the same row are arranged at equal intervals in the second direction.

In the embodiments of the present disclosure, the plurality of first spacers 31 located in two adjacent rows are arranged in a staggered manner in the second direction.

For example, two rows of spacers are taken as an example for explanation. Regions in which the two rows of first spacers 31 are distributed have the same size in the second direction, and distances between the first spacer 31 in one row of spacers and two adjacent first spacers 31 in the other row of spacers are equal.

FIG. 18 is a schematic diagram of an arrangement of spacer walls 33 of a display panel 100 according to yet some exemplary embodiments of the present disclosure. With reference to FIG. 18, the display panel 100 may further include a plurality of rows of first spacer walls 33. The plurality of rows of first spacer walls 33 are arranged in a plurality of rows of spacers in the first direction. The plurality of first spacer walls 33 located in the same row are arranged at equal intervals in the second direction. Each first spacer wall 33 includes a plurality of first spacers 31. The plurality of first spacers 31 are connected in the second direction to form a first spacer wall 33. The plurality of second spacers 32 are connected in the second direction to form a second spacer wall.

In the embodiments of the present disclosure, the plurality of first spacer walls 33 located in two adjacent rows are arranged in a staggered manner in the second direction. Two rows of spacers are taken as an example for explanation. Regions in which the two rows of first spacer walls 33 are distributed have the same size in the second direction, and distances between the first spacer 31 in one row of first spacer walls 33 and two adjacent first spacers 31 in the other row of first spacer walls 33 are equal.

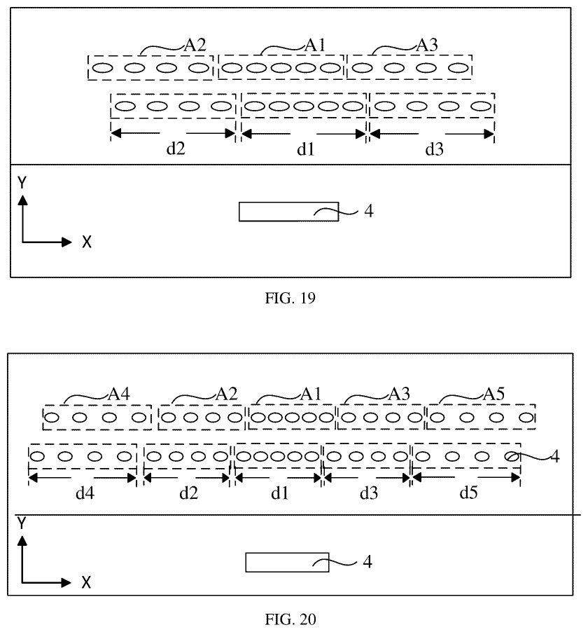

FIG. 19 is a schematic diagram of another distribution density of spacers of a display panel according to yet some exemplary embodiments of the present disclosure. FIG. 20 is a schematic diagram of another distribution density of spacers of a display panel according to yet some exemplary embodiments of the present disclosure. With reference to FIG. 19 and FIG. 20, two rows of first spacer walls 33 are schematically shown in the figures. The distribution density of each row of first spacer walls 33 is the same as the distribution method of the single row spacers as described above. It may be understood that the spacers are not only helpful in preventing the display panel 100 from warping, but also helpful in preventing the sealing adhesive 2 from overflowing. In this case, the first spacers 31 with different density gradients are disposed in the second direction. Due to the significant influence of temperature field of the periphery of the driving chip 4, the distribution density of the first spacers 31 close to the driving chip 4 is high, so as to further better suppress the warping of the display panel 100.

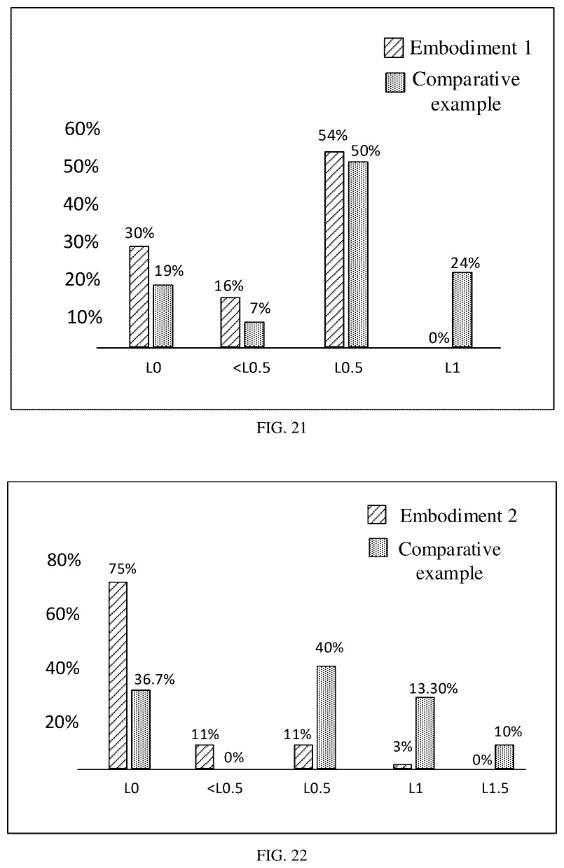

FIG. 21 is a statistical chart of effects between a display panel of an embodiment and a display panel of a comparative example according to some exemplary embodiments of the present disclosure. FIG. 22 is a statistical chart of effects between a display panel of an embodiment and a display panel of a comparative example according to some other exemplary embodiments of the present disclosure.

With reference to FIG. 21, the display panel of FIG. 4 is used as the display panel in an embodiment 1, and the display panel without spacers in FIG. 4 is used as the display panel in a comparative example. The same number of display panels were tested for both the embodiment 1 and the comparative example, and results as shown in FIG. 21 are obtained. Horizontal ordinate represents a level of COG Mura, and the higher the horizontal value, the more severe the degree of COG Mura. For example, compared to an L0.5 display panel, L1 has a more severe degree of COG Mura. Vertical ordinate represents a ratio of the number of display panels of which the level of COG Mura is between two adjacent levels to the total number of display panels.

According to the analysis of FIG. 21, it may be concluded that the level of COG Mura of the display panel in the embodiment 1 has all decreased to below L1, and the level of L1 and below decreases by 24%. The number ratio of display panels with a zero reference (0%) in the embodiment 1 has increased from 19% to 30%. It may be seen that disposing a single row of spacers is beneficial in preventing the display panel from warping.

With reference to FIG. 22, the display panel of FIG. 15 is used as the display panel in an embodiment 2, and the display panel without spacers in FIG. 15 is used as the display panel in a comparative example. The same number of display panels were tested for both the embodiment 2 and the comparative example, and results shown in FIG. 22 are obtained.

According to the analysis of FIG. 22, it may be concluded that the level of COG Mura of the display panel in the embodiment 2 has all decreased to below L1.5, and the level of L1.5 and below decreases by 10%. The number ratio of display panels with a zero reference (0%) in the embodiment 2 has increased from 36.70% to 75%. The proportion of display panels exceeding the L1 level in the embodiment 2 is only 3%. It may be seen that disposing two rows of staggered first spacers 31 is beneficial for preventing the display panel from warping.

Some exemplary embodiments of the present disclosure also provide a display device. The display device includes a display panel as described above.

It should be understood that the display device according to some exemplary embodiments of the present disclosure has all the features and advantages of the display panel described above, and these features and advantages may be referred to the above description of the display panel, which will not be repeated here.

Although some embodiments of the entire inventive concept of the present disclosure have been illustrated and described, those of ordinary skill in the art will understand that changes may be made to these embodiments without departing from the principles and spirit of the entire inventive concept of the present disclosure, and the scope of the present disclosure is limited by the claims and their equivalents.

1. A display panel comprising a display region and a peripheral region, wherein the peripheral region at least partially surrounds the display region, the peripheral region comprises a first sub peripheral region, and the display panel comprises:
a first substrate comprising:
a first base;
a black matrix and a plurality of color resistance portions on the first base, wherein the plurality of color resistance portions are arranged in an array in a first direction and a second direction in the display region; and
a plurality of spacers on the first base, wherein the plurality of spacers comprise a first spacer located in the first sub peripheral region and a second spacer located in the display region;
a second substrate opposite to the first substrate, wherein the second substrate comprises:
a second base;
a plurality of pixel driving circuits on the second base, wherein the plurality of pixel driving circuits are arranged in an array in the first direction and the second direction in the display region; and
a driving chip on the second base, wherein the driving chip is located in the first sub peripheral region; and
a sealing adhesive between the first substrate and the second substrate, wherein the sealing adhesive surrounds the display region,
wherein the first spacer is located on a side of the sealing adhesive away from the display region, the first spacer is located between the sealing adhesive and the driving chip in the first direction, and the first direction is a direction pointing from a center of the display region to the driving chip; and
wherein the display panel further comprises a cushion layer structure on the first base, and the first spacer is located on a side of the cushion layer structure facing the second substrate.

2. The display panel of claim 1, wherein an orthographic projection of the first spacer on the first base falls within an orthographic projection of the cushion layer structure on the first base.

3. The display panel of claim 1, wherein an orthographic projection of the first spacer in the first direction at least partially overlaps with an orthographic projection of the driving chip in the first direction.

4. The display panel of claim 3, wherein
the first spacer and the sealing adhesive are spaced apart in the first direction, and a minimum interval distance between the first spacer and the sealing adhesive in the first direction is a first interval distance;
the first spacer and the driving chip are spaced apart in the first direction, and a minimum interval distance between the first spacer and the driving chip in the first direction is a second interval distance; and
the first interval distance is less than the second interval distance.

5. The display panel of claim 4, wherein
the display panel comprises a plurality of first spacers, and the plurality of first spacers are located between the sealing adhesive and the driving chip in the first direction; and
the plurality of first spacers are spaced apart in the second direction, and the second direction is perpendicular to the first direction.

6. The display panel of claim 1, wherein a size of a region in which a plurality of first spacers are distributed in the second direction is greater than a size of the driving chip in the second direction.

7. The display panel of claim 1, wherein
a region in which a plurality of first spacers are distributed comprises a first sub-region, a second sub-region and a third sub-region, wherein the second sub-region and the third sub-region are located on two sides of the first sub-region in the second direction respectively, and the first sub-region is opposite to the driving chip in the first direction; and
a ratio of a size of the second sub-region in the second direction to a size of the first sub-region in the second direction is between 0.1 and 0.4; and/or, a ratio of a size of the third sub-region in the second direction to the size of the first sub-region in the second direction is between 0.1 and 0.4.

8. The display panel of claim 1, wherein
a region in which a plurality of first spacers are distributed comprises a first sub-region, a second sub-region and a third sub-region, wherein the second sub-region and the third sub-region are located on two sides of the first sub-region in the second direction respectively, and the first sub-region is opposite to the driving chip in the first direction; and
the plurality of first spacers have a first distribution density in the first sub-region, the plurality of first spacers have a second distribution density in the second sub-region, the plurality of first spacers have a third distribution density in the third sub-region, the first distribution density is greater than the second distribution density, and the first distribution density is greater than the third distribution density.

9. The display panel of claim 8, wherein
the region in which the plurality of first spacers are distributed further comprises a fourth sub-region and a fifth sub-region, the fourth sub-region is located on a side of the second sub-region away from the first sub-region in the second direction, and the fifth sub-region is located on a side of the third sub-region away from the first sub-region in the second direction; and
the plurality of first spacers have a fourth distribution density in the fourth sub-region, the plurality of first spacers have a fifth distribution density in the fifth sub-region, the second distribution density is greater than the fourth distribution density, and the third distribution density is greater than the fifth distribution density.

10. The display panel of claim 9, wherein the second distribution density is equal to the third distribution density; and/or the fourth distribution density is equal to the fifth distribution density, and
wherein a ratio of a size of the second sub-region in the second direction to a size of the first sub-region in the second direction is between 0.1 and 0.4; and/or a ratio of a size of the third sub-region in the second direction to the size of the first sub-region in the second direction is between 0.1 and 0.4.

11. (canceled)

12. The display panel of claim 1, wherein a plurality of first spacers are arranged in one row in the first direction, and the plurality of first spacers located in the row are arranged at equal intervals in the second direction.

13. The display panel of claim 1, wherein a plurality of first spacers are arranged in a plurality of rows in the first direction, and the plurality of first spacers located in the same row are arranged at equal intervals in the second direction, and
wherein the plurality of first spacers located in two adjacent rows are aligned in the second direction; and/or the plurality of first spacers located in two adjacent rows are staggered in the second direction.

14. (canceled)

15. The display panel of claim 1, wherein an orthographic projection of the first spacer on the first base has a first size in the first direction and a second size in the second direction, and a ratio of the second size to the first size is no less than 20.

16. The display panel of claim 1, wherein an orthographic projection of the first spacer on the first base has a first size in the first direction and a second size in the second direction, and a ratio of the second size to the first size is no more than 5;
wherein an orthographic projection of the second spacer on the first base has a third size in the first direction, and the first size is equal to the third size, and
wherein an orthographic projection of the second spacer on the first base has a fourth size in the second direction, and the second size is equal to the fourth size.

17. (canceled)

18. The display panel of claim 1, wherein
the first spacer has a first thickness in a third direction perpendicular to both the first direction and the second direction;
the second spacer has a second thickness in the third direction; and
the first thickness is equal to the second thickness.

19. (canceled)

20. The display panel of claim 1, wherein the cushion layer structure comprises a first cushion layer, and the first cushion layer is located on the same layer as the black matrix located in the display region or the plurality of color resistance portions.

21. The display panel of claim 20, wherein the cushion layer structure comprises the first cushion layer and a second cushion layer, the second cushion layer is located on a side of the first cushion layer facing the second substrate, the first cushion layer is located on the same layer as the black matrix located in the display region, and the second cushion layer is located on the same layer as the plurality of color resistance portions located in the display region.

22. The display panel of claim 20, wherein
the first substrate further comprises a cover layer located on a side of the plurality of color resistance portions facing the second substrate; and
the cushion layer structure comprises a first cushion layer, a second cushion layer and a third cushion layer, the second cushion layer is located on a side of the first cushion layer facing the second substrate, the third cushion layer is located on a side of the second cushion layer facing the second substrate, the first cushion layer is located on the same layer as the black matrix located in the display region, the second cushion layer is located on the same layer as the plurality of color resistance portions located in the display region, and the third cushion layer is located on the same layer as the cover layer located in the display region.

23. The display panel of claim 21, wherein an orthographic projection of the first cushion layer on the first base is spaced apart from an orthographic projection of the sealing adhesive on the first base, or
wherein an orthographic projection of the first cushion layer on the first base at least partially overlaps with an orthographic projection of the sealing adhesive on the first base, wherein the display panel further comprises a groove between the first cushion layer and the black matrix located in the display region, and an orthographic projection of the groove on the first base falls within the orthographic projection of the sealing adhesive on the first base.

24-25. (canceled)

26. A display device comprising the display panel of claim 1.
